(19) United States
(12) Patent Application Publication
(10) Pub. No.: US 2023/0069428 A1
(43) Pub. Date: Mar. 2, 2023

(54) FUEL CELL VEHICLE

(71) Applicant: TOYOTA JIDOSHA KABUSHIKI KAISHA, Toyota-shi (JP)

(72) Inventor: Yoshiaki NAGANUMA, Toyota-shi (JP)

(73) Assignee: TOYOTA JIDOSHA KABUSHIKI KAISHA, Toyota-shi (JP)

(21) Appl. No.: 17/822,220

(22) Filed: Aug. 25, 2022

(30) Foreign Application Priority Data
Aug. 26, 2021 (JP) 2021-137756

(51) Int. Cl. B60L 58/30; B60Q 9/00; B60L 58/12; B60L 50/75; H01M 16/00; H01M 8/04858; H01M 10/48

(52) U.S. Cl. CPC B60L 58/30; B60L 50/75; B60L 58/12; B60Q 9/00; H01M 8/0488; H01M 10/48; H01M 16/006; B60L 2250/00; H01M 2220/20; H01M 2250/20

(57) ABSTRACT

A fuel cell vehicle may include: a fuel cell unit; a battery unit connected to an output terminal of the fuel cell unit in parallel; a traction motor configured to be driven by electric power supplied from at least one of the fuel cell unit and the battery unit; and a controller configured to control the fuel cell unit to maintain a FC voltage outputted from the fuel cell unit at an idling voltage which is higher than zero and lower than a battery voltage outputted from the battery unit while driving of the traction motor is prohibited.

### CROSS-REFERENCE TO RELATED APPLICATION

This application claims priority based on Japanese patent application No. 2021-137756 filed on Aug. 26, 2021, contents of which are hereby incorporated by reference into the present application.

### TECHNICAL FIELD

The technique disclosed herein relates to a fuel cell vehicle comprising a fuel cell unit configured to supply electric power to a traction motor.

### BACKGROUND

It is known that a fuel cell stack of a fuel cell unit degrades due to repetitive activation and stop (Japanese Patent Application Publication No. 2020-181757, Japanese Patent Application Publication No. 2014-50240). To slow progression of degradation, a fuel cell system described in Japanese Patent Application Publication No. 2020-181757 operates a fuel cell stack for a predetermined period after a main switch of a vehicle is switched from on to off. A vehicle described in Japanese Patent Application Publication No. 2014-50240 maintains a voltage of its fuel cell when a place where the vehicle is switched from on to off is not a predetermined location.

Further, the fuel cell system described in Japanese Patent Application Publication No. 2020-181757 includes a battery, and the battery is connected to the fuel cell stack. When an amount of remaining charge in the battery is low, the battery is charged using the fuel cell stack. When the battery is fully charged, the fuel cell stack is stopped.

### SUMMARY

In the fuel cell system described in Japanese Patent Application Publication No. 2020-181757, the fuel cell is stopped when the battery is fully charged. The technique described in Japanese Patent Application Publication No. 2014-50240 does not consider a battery connected to the fuel cell in parallel. The present disclosure relates to a fuel cell vehicle in which a fuel cell (fuel cell unit) and a battery (battery unit) are connected in parallel, and provides a technique capable of mitigating degradation of the fuel cell unit as compared to the conventional techniques.

The fuel cell vehicle disclosed herein comprises a fuel cell unit, a battery unit, a traction motor, and a controller. An output terminal of the battery unit is connected to an output terminal of the fuel cell unit in parallel. The traction motor is configured to be driven by electric power supplied from at least one of the fuel cell unit and the battery unit. The controller is configured to control the fuel cell unit to maintain an output voltage of the fuel cell unit (FC voltage) at a predetermined idling voltage which is higher than zero and lower than an output voltage of the battery unit (battery voltage) while driving of the traction motor is prohibited. The state in which the driving of the traction motor is prohibited may for example be a state in which an inverter configured to convert electric power of the fuel cell unit or the battery unit to electric power for driving the traction motor is stopped, or a state in which the traction motor or driving wheels are locked.

Since the idling voltage is lower than the battery voltage, when the FC voltage is maintained at the idling voltage, electric current is not outputted from the fuel cell unit. In the fuel cell vehicle disclosed herein, while the driving of the traction motor is prohibited, electric current is not outputted from the fuel cell unit but the FC voltage is maintained at the idling voltage. Even when the fuel cell unit and the battery unit are connected in parallel, the fuel cell unit is not stopped. Thus, degradation of the fuel cell stack of the fuel cell unit can be mitigated.

The controller may be configured to control the fuel cell unit to maintain the FC voltage at the idling voltage while the driving of the traction motor is prohibited and a remote key of the fuel cell vehicle is outside the fuel cell vehicle. A user is unlikely to drive the fuel cell vehicle while the remote key is outside the vehicle. In such a situation, maintaining the FC voltage at the idling voltage eliminates unnecessary fuel consumption.

In a case where an amount of remaining charge in the battery unit is lower than a lower charge threshold while the driving of the traction motor is prohibited, the controller may be configured to control the fuel cell unit so that the FC voltage exceeds the battery voltage until the amount of remaining charge in the battery unit reaches a predetermined upper charge threshold. By increasing the FC voltage when the amount of the remaining charge in the battery unit is low, the battery unit can be charged using the fuel cell unit. This process is suitable especially when one or more other electric devices which consume electric power are connected to the battery unit.

Details of the technique disclosed herein and further developments will be described in “DETAILED DESCRIPTION”.

### BRIEF DESCRIPTION OF DRAWINGS

FIG. 1 illustrates a block diagram of an electric system of a fuel cell vehicle of an embodiment.

FIG. 2 illustrates a flowchart of FC unit control.

FIG. 3 illustrates the flowchart of the FC unit control (continuation of FIG. 2).

FIG. 4 illustrates a flowchart of FC unit control of a variant.

### DETAILED DESCRIPTION

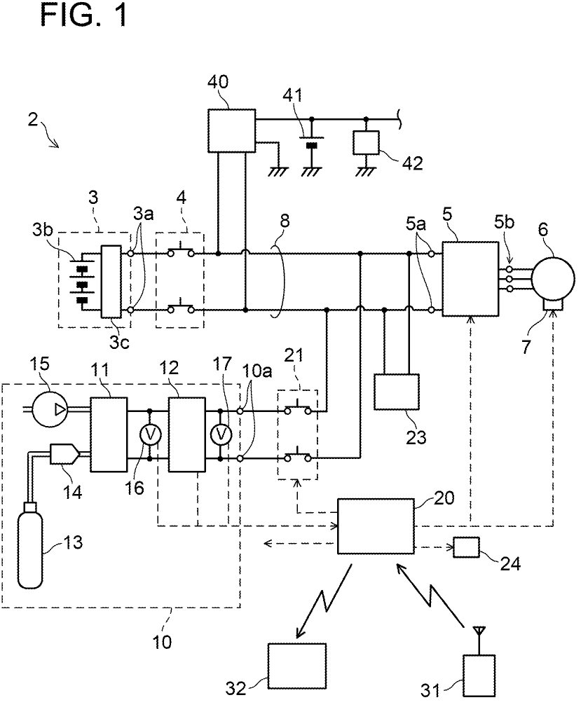

Referring to drawings, a fuel cell vehicle 2 of an embodiment will be described. Hereafter, a “fuel cell” will be referred to as “FC” for convenience of explanation. FIG. 1 illustrates a block diagram of an electric system of the FC vehicle 2 (fuel cell vehicle 2). The FC vehicle 2 includes an FC unit 10, a battery unit 3, an inverter 5, a traction motor 6, and a controller 20. Broken lines in FIG. 1 indicate signal lines.

The FC vehicle 2 is configured to travel using the traction motor 6. Output terminals 10a of the FC unit 10 and output terminals 3a of the battery unit 3 are connected to DC terminals 5a of the inverter 5 in parallel. The traction motor 6 is connected to AC terminals 5b of the inverter 5. The inverter 5 is configured to convert DC power outputted from the FC unit 10 and the battery unit 3 to (AC) driving power for the traction motor 6. The inverter is controlled by the controller 20. The traction motor 6 includes a brake 7 configured to prohibit rotation of the traction motor 6. Hereinafter, for convenience of explanation, the traction motor 6 will be referred to as a motor 6.

The battery unit 3 includes a battery 3b and a voltage converter 3c. The battery 3b is a rechargeable secondary cell, and is for example a lithium-ion battery. The voltage converter 3c has a step-up function of stepping up an output voltage of the battery 3b and outputting the same to the output terminals 3a and a step-down function of stepping down the voltage applied to the output terminals 3a (voltage of regenerative power generated by the motor 6) and outputting the same to the battery 3b. The voltage converter 3c is a bidirectional DC-DC converter. The voltage converter 3c is controlled by the controller 20. The output voltage of the voltage converter 3c corresponds to the output voltage of the battery unit 3.

The output terminals 3a of the battery unit 3 are connected to the DC terminals 5a of the inverter 5 via a BT relay 4. The controller 20 closes the BT relay 4 when a main switch (not illustrated) of the FC vehicle 2 is turned on, and connects the output terminals 3a of the battery unit 3 to the DC terminals 5a of the inverter 5. The BT relay 4 may be disposed between the battery 3b and the voltage converter 3c.

The FC unit 10 includes a FC stack 11, an air compressor 15 configured to supply air to the FC stack 11, a hydrogen tank 13, an injector 14 configured to supply hydrogen gas in the hydrogen tank 13 to the FC stack 11, and a step-up converter 12.

The FC unit 10 is controlled by the controller 20. The controller 20 controls the air compressor 15 and the injector 14 to adjust output of the FC stack 11. The step-up converter 12 is connected between output terminals of the FC stack 11 and the output terminals 10a of the FC unit 10. The step-up converter 12 is configured to step-up the output voltage of the FC stack 11. A voltage sensor 16 is connected to the output terminals of the FC stack 11 and a voltage sensor 17 is connected to the output terminals of the step-up converter 12. Measurement values of the voltage sensors 16, 17 are transmitted to the controller 20. The controller 20 can learn the output voltage of the FC stack 11 and the output voltage of the step-up converter 12 from the measurement values of the voltage sensors 16, 17. The output voltage of the step-up converter 12 corresponds to, in other words, the output voltage of the FC unit 10.

The output terminals 10a of the FC unit 10 are connected to the DC terminals 5a of the inverter 5 via a FC relay 21. The controller 20 closes the FC relay 21 when the main switch of the FC vehicle 2 is turned on, and connects the output terminals 10a of the FC unit 10 to the DC terminals 5a of the inverter 5. The controller 20 opens the FC relay 21 when a predetermined condition is met. Examples of the predetermined condition will be described later.

A voltage converter 40 and a high-voltage device 23 are connected to electric power lines 8 that connect the battery unit 3, the inverter 5 and the FC unit 10. The high-voltage device 23 is for example an air conditioner which conditions a temperature in a cabin. The voltage converter 40 is configured to step down the output voltage of the battery unit 3 or the output voltage of the FC unit 10 to charge a sub battery 41. One or more low-power devices 42 such as a radio are connected to the sub battery 41.

When the FC vehicle 2 travels, the controller 20 determines a target electric power for the motor 6 based on a position of an accelerator and vehicle speed. The controller 20 controls the FC unit 10 to match the output electric power of the FC unit 10 with the target electric power. Further, the controller 20 controls the step-up converter 12 and/or the voltage converter 3c so that the output voltage of the FC unit 10 exceeds the output voltage of the battery unit 3. The controller 20 determines a target voltage for the DC terminals 5a of the inverter 5 from the target electric power of the motor 6. The controller 20 controls the step-up converter 12 to match the output voltage of the FC unit 10 with the target voltage for the DC terminals 5a, and controls the voltage converter 3c so that the output voltage of the battery unit 3 becomes slightly lower than the target voltage.

The controller 20 controls an indicator 24. The indicator 24 is a warning lamp disposed on a body or in the cabin of the FC vehicle 2. The controller 20 is also configured to communicate with a remote key 31 of the FC vehicle 2 and a terminal device 32 which the user possesses. The indicator 24, the remote key 31 and the terminal device 32 will be described later.

Hereafter, for convenience of explanation, the output voltage of the FC unit 10 will be referred to as a FC voltage and the output voltage of the battery unit 3 will be referred to as a battery voltage.

When the FC voltage is higher than the battery voltage, the electric power of the FC unit 10 (electric power of the FC stack 11) is supplied to the inverter 5 (motor 6), and the electric power of the battery unit 3 is not supplied to the inverter 5 (motor 6). Further, when the battery unit 3 (battery 3b) is not fully charged, the battery unit 3 (battery 3b) is charged using a part of the output power of the FC unit 10.

It is known that the FC stack 11 degrades by frequently repeating activation and stop. Further, the FC stack 11 continuing to output electric current at a low voltage also degrades the FC stack 11. This is partly because variations in oxygen concentrations in a plurality of single cells included in the FC stack 11 occur and these variations in turn cause variations in output voltages of the plurality of single cells. The FC vehicle 2 can mitigate such degradation by reducing frequency of activation and stop of the FC stack 11 and further avoiding “low-current outputting state” as possible.

As described above, when the motor 6 is driven, the FC stack 11 outputs the electric power required for the motor 6. When driving of the motor 6 is prohibited, the controller 20 controls the FC unit 10 to maintain the FC voltage at an idling voltage.

Example cases in which the driving of the motor 6 is prohibited include a case in which the inverter 5 is stopped, a case in which the motor 6 is locked, and the like. The motor 6 is locked when a shift lever (not illustrated) is in a P (parking) position, when a side brake is applied, when a brake pedal is pressed, and the like. When the shift lever is in the P position and also when the side brake is applied, the brake 7 configured to lock the motor 6 is operated and the driving of the motor 6 is prohibited.

The idling voltage is set to a value that is lower than the battery voltage and equal to or higher than a value defined by multiplying a minimum output voltage of the single cell in the FC stack 11 by the number of the single cells in the FC stack 11. Since the idling voltage is lower than the battery voltage, the electric power (electric current) is not outputted from the FC stack 11 while the FC voltage is maintained at the idling voltage. Therefore, reaction does not take place in the FC stack 11. When the reaction does not take place in the FC stack 11 and the FC voltage is maintained at the idling voltage, the voltages of the plurality of single cells approach the minimum output voltage and are uniformized at the minimum output voltage. Since the oxygen concentrations (and hydrogen concentrations) of the plurality of single cells are uniformized, the degradation can be mitigated.

Even while the reaction does not take place in the FC stack 11, the hydrogen gas and the oxygen gas in the FC stack 11 are gradually lost. When the hydrogen gas and the oxygen gas in the FC stack 11 are gradually lost, the FC voltage decreases. The controller 20 adjusts the concentrations of the hydrogen gas and the oxygen gas in the FC stack 11 to maintain the FC voltage at the idling voltage. In other words, the controller 20 controls the FC unit 10 to maintain the FC voltage at the idling voltage.

While the FC voltage is maintained at the idling voltage, the FC stack 11 does not output electric current, but is not stopped (the FC unit 10 is operated to maintain the FC voltage at the idling voltage). By virtue of the above processes by the controller 20, frequency of activation and stopping of the FC unit 10 (FC stack 11) can be kept low.

Further, while the FC voltage is maintained at the idling voltage, the FC stack 11 does not output electric current. By virtue of the above processes by the controller 20, the FC stack 11 can be prevented from entering the low-current output state.

As described above, several electric devices (e.g., the high-voltage device 23 and the voltage converter 40) other than the inverter 5 (motor 6) are connected to the power lines 8. When these devices are operated, the electric power of the battery unit 3 is consumed even when the inverter 5 (motor 6) is not operated. When an amount of remaining charge in the battery unit 3 becomes low, the high-voltage device 23 (e.g., air conditioner) and/or the voltage converter 40 cannot be operated. To address this, in a case where the amount of the remaining charge in the battery unit 3 (battery 3b) is lower than a predetermined lower charge threshold even though the driving of the motor 6 is prohibited, the controller 20 controls the FC unit 10 so that the FC voltage exceeds the battery voltage until the amount of the remaining charge reaches a predetermined upper charge threshold.

The controller 20 may open the FC relay 21 and electrically separate the output terminals 10a of the FC unit 10 from the battery unit 3 and the inverter 5 (motor 6) while maintaining the FC voltage at the idling voltage. By opening the FC relay 21, output of the FC unit 10 (FC stack 11) can be ensured to stop.

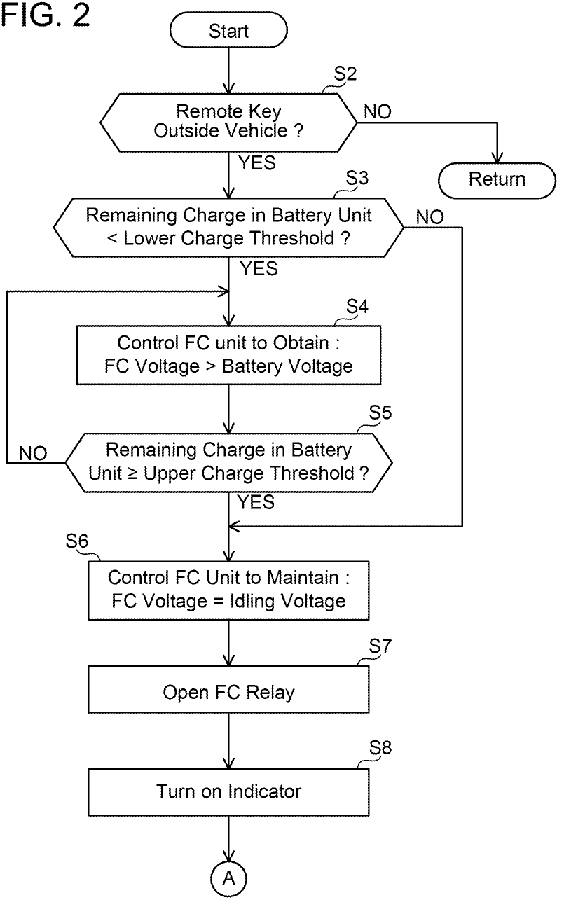

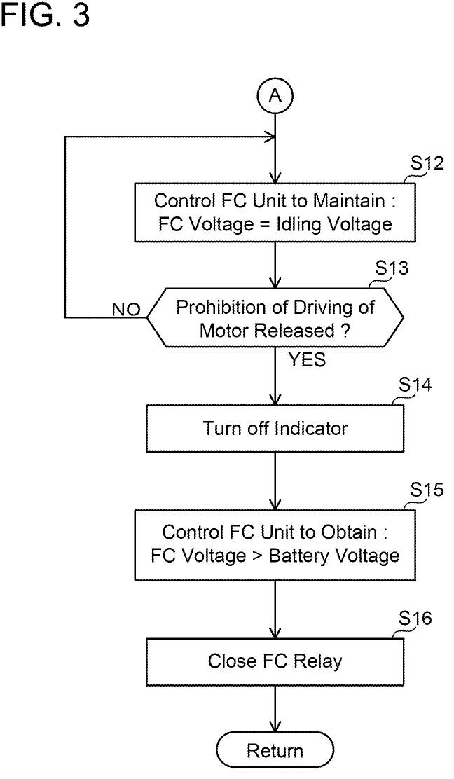

FC unit control executed by the controller 20 will be explained referring to the flowcharts in FIGS. 2 and 3. The process of FIG. 2 is started when the driving of the motor 6 is prohibited. Before the process of FIG. 2 is started, the BT relay 4 and the FC relay 21 are closed, and both the battery unit 3 and the FC unit 10 are connected to the inverter 5 (motor 6).

As described above, the controller 20 can communicate with the remote key 31. The remote key 31 is a device configured to transmit an instruction (instruction to switch on and off of the main switch of the FC vehicle 2) to the controller 20 with radio waves. The controller 20 monitors whether the remote key 31 is inside or outside the vehicle, and if it is detected that the remote key 31 is inside the vehicle (step S2: NO), the controller 20 stops the process. This is because when the remote key 31 is inside the vehicle, it is highly likely that the user is inside the vehicle, in which case prohibition of the driving of the motor 6 is likely to soon be released (be canceled).

When the remote key 31 is outside the vehicle, the prohibition of the driving of the motor 6 is unlikely to be released for a while, and thus in this case, the controller 20 maintains the FC voltage at the idling voltage as described below and prevents the degradation of the FC stack 11.

When it is detected that the remote key 31 is outside the vehicle (step S2: YES), the controller 20 checks the amount of the remaining charge in the battery unit 3 (battery 3b) (step S3). When the amount of the remaining charge in the battery unit 3 is not lower than the lower charge threshold, the controller 20 controls the FC unit 10 to maintain the FC voltage at the idling voltage and opens the FC relay 21 (step S3: NO, S6, S7). Further, the controller 20 turns on the indicator 24 (step S8). As described above, the indicator 24 is a warning lamp disposed on the body or in the cabin of the FC vehicle 2. The indicator 24 is a warning lamp which notifies the user that the FC unit 10 is controlled to maintain the FC voltage at the idling voltage. When the indicator 24 is disposed in the cabin, the indicator 24 is disposed at a position that can be visually recognized from outside the vehicle.

On the other hand, when the amount of the remaining charge in the battery unit 3 is lower than the lower charge threshold in step S3, the controller 20 controls the FC unit 10 so that the FC voltage exceeds the battery voltage (step S3: YES, S4). When the FC voltage exceeds the battery voltage, the electric power flows from the FC unit 10 (FC stack 11) to the battery unit 3 and the battery unit 3 is charged. Even when the high-voltage device 23 and the voltage converter 40 are consuming the electric power of the battery unit 3, the electric power is supplied from the FC stack 11 to the battery unit 3, by which the electric power of the battery unit 3 will not be depleted.

The controller 20 charges the battery unit 3 until the amount of the remaining charge in the battery unit 3 reaches the upper charge threshold (step S5: NO, S4). When the remaining charge in the battery unit 3 (the amount of the residual electric power in the battery unit 3) reaches the upper charge threshold, the controller 20 controls the FC unit 10 to maintain the FC voltage at the idling voltage (step S5: YES, S6). The processes after step S6 are performed as previously described.

The controller 20 maintains the FC voltage at the idling voltage until the prohibition of driving of the motor 6 is released (step S13: NO, S12). While the FC voltage is maintained at the idling voltage, the FC unit 10 (FC stack 11) does not output electric current, but the controller 20 controls the FC unit 10 to match the FC voltage with the idling voltage. During the above control, switching between activation/stop of the FC unit 10 is not performed, and the low-current output state is also prevented.

When the prohibition of driving of the motor 6 is released (canceled), the controller 20 turns off the indicator 24 and controls the FC unit 10 so that the FC voltage exceeds the battery voltage (step S13: YES, S14, S15). At last, the controller 20 closes the FC relay 21 (step S16). These processes allow the FC vehicle 2 to start traveling at any moment. In other words, when a driver presses the accelerator, the controller 20 drives the inverter 5 and electric power is supplied from the FC unit 10 to the inverter 5 (motor 6).

One example of the conditions for releasing the prohibition of the driving of the motor 6 is the user operating the shift lever and selecting a position other than the P position (any one of reverse, neutral and drive positions). Another example of the conditions for releasing the prohibition of the driving of the motor 6 is release of the side brake.

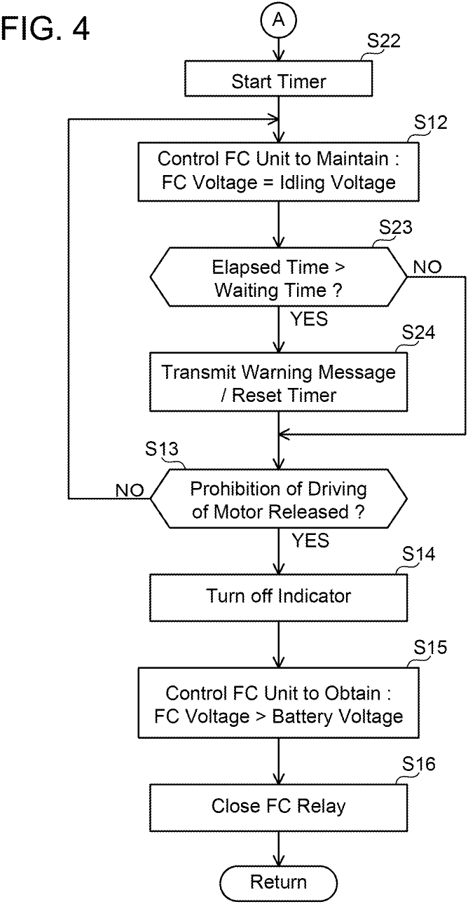

FIG. 4 illustrates a flowchart of a process of a variant performed by the controller 20. The variant is different from the embodiment in that steps S22, S23, and S24 are added to the flowchart of FIG. 3. Hereafter, the variant will be explained, focusing on steps S22, S23, S24.

In step S8 of FIG. 2, after turning on the indicator 24, the controller 20 starts a timer (FIG. 4, step S22). The timer is a variable in a program of the controller 20, and is a variable for measuring time. Next, the controller 20 controls the FC unit 10 to maintain the FC voltage at the idling voltage until the prohibition of the driving of the motor 6 is released (step S12, S13: NO).

While maintaining the FC voltage at the idling voltage, the controller 20 checks time that has elapsed after the timer was started (step S23). When the elapsed time exceeds a predetermined waiting time, the controller 20 transmits a message indicating that the FC unit 10 is maintained in an idle state past the waiting time (warning message) to the terminal device 32 which the user possesses (step S24). At the same time, the controller 20 resets the timer (step S24). The “idle state” means a state in which the FC voltage is maintained at the idling voltage. The warning message notifies the user that the FC vehicle 2 has been maintained in the idle state over a long period of time.

In step S24, the timer is reset. The idle state still continues after the reset (step S13: NO). Each time the elapsed time of the timer exceeds the waiting time, the controller 20 transmits the warning message to the user’s terminal device 32 (step S23: YES, S24).

While the FC vehicle 2 is maintained in the idle state, the controller 20 periodically transmits the warning message to the user’s terminal device 32. The FC vehicle 2 can notify the user that the FC vehicle 2 has been maintained in the idle state over a long period of time. The terminal device 32 may be any type of information device, such as a smartphone, a tablet, a microcomputer, and the like.

As described above, the FC vehicle 2 of the embodiment can reduce the frequency of activation/stop of the FC stack 11 and further prevent the FC stack 11 from entering the low-current output state.

Points to be noted regarding the technique described in the embodiment will be described. The FC unit 10 (FC stack 11) being stopped means that the air compressor 15 and the injector 14 are stopped. As described above, in the idle state, the controller 20 maintains the FC voltage at the idling voltage by adjusting the hydrogen concentration and the oxygen concentration in the FC stack 11 with controlling the air compressor 15 and the injector 14. Accordingly, in the idle state, the FC unit 10 (FC stack 11) is operating rather than in a complete stop.

In the idle state, the controller 20 may control the step-up converter 12 so that a step-up ratio is kept 1. Power consumption by the step-up converter 12 can be reduced. Further, the step-up ratio of the voltage converter 3c can be kept low. In other words, the power consumption by the voltage converter 3c can also be kept low.

On the other hand, in the idle state, the controller 20 may control the voltage converter 3c so that the FC voltage becomes lower than the battery voltage.

The battery unit 3 of the embodiment includes the voltage converter 3c, however, it may not include the voltage converter 3c. In other words, the battery unit may only include a battery. The FC unit 10 of the embodiment includes the step-up converter 12, however, it may not include the step-up converter 12. The output of the FC unit 10 may be the output of the FC stack 11.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present specification or drawings provide technical utility either independently or through various combinations. The present disclosure is not limited to the combinations described at the time the claims are filed. Further, the purpose of the examples illustrated by the present specification or drawings is to satisfy multiple objectives simultaneously, and satisfying any one of those objectives gives technical utility to the present disclosure.

What is claimed is:

1. A fuel cell vehicle comprising:
a fuel cell unit;
a battery unit connected to an output terminal of the fuel cell unit in parallel;
a traction motor configured to be driven by electric power supplied from at least one of the fuel cell unit and the battery unit; and
a controller configured to control the fuel cell unit to maintain a FC voltage outputted from the fuel cell unit at an idling voltage which is higher than zero and lower than a battery voltage outputted from the battery unit while driving of the traction motor is prohibited.

2. The fuel cell vehicle of claim 1, wherein the controller is configured to control the fuel cell unit to maintain the FC voltage at the idling voltage while the driving of the traction motor is prohibited and a remote key of the fuel cell vehicle is outside the fuel cell vehicle.

3. The fuel cell vehicle of claim 1, wherein in a case where an amount of remaining charge in the battery unit is lower than a lower charge threshold while the driving of the traction motor is prohibited, the controller is configured to control the fuel cell unit so that the FC voltage exceeds the battery voltage until the amount of the remaining charge in the battery unit reaches an upper charge threshold.

4. The fuel cell vehicle of claim 1, wherein the controller is configured to electrically separate the fuel cell unit from the battery unit and the traction motor while maintaining the FC voltage at the idling voltage.

5. The fuel cell vehicle of claim 1, further comprising an indicator which indicates that the controller is maintaining the FC voltage at the idling voltage.

6. The fuel cell vehicle of claim 5, wherein the indicator is a lamp disposed on a body of the fuel cell vehicle or disposed in a cabin of the fuel cell vehicle.

7. The fuel cell vehicle of claim 1, wherein the controller is configured to transmit a warning notification to a device outside the fuel cell vehicle when a period during which the FC voltage is maintained at the idling voltage reaches a predetermined period.

8. The fuel cell vehicle of claim 1, wherein the idling voltage is equal to or higher than a voltage defined by multiplying a minimum output voltage of a single cell in a fuel cell stack of the fuel cell unit by a number of cells in the fuel cell stack.
